(19) United States
(12) Patent Application Publication
(10) Pub. No.: US 2006/0087580 A1
(43) Pub. Date: Apr. 27, 2006

(54) Variable focal distance image reader

(75) Inventor: Xinjun Xie, Ottawa (CA)

Correspondence Address: PEARNE & GORDON LLP, 1801 EAST 9TH STREET, SUITE 1200, CLEVELAND, OH, 44114-3108, US

(73) Assignee: Symagery Microsystems Inc.

(21) Appl. No.: 10/970,376

(22) Filed: Oct. 21, 2004

(51) Int. Cl. G02B 13/16

(52) U.S. Cl. 348/335

(57) ABSTRACT

A camera module, having a objective lens that can be displacd to set the focal distance for a number of predetermined applications, is described. The objective lens is displaced by an electro-mechanical system. An operator selects a particular focal distance corresponding to a particular scanning application through a control interface. A current source supplies a current proportional to the selected focal distance to a solenoid. The solenoid plunger is connected to a lever that is coupled to the objective lens to move it to the selected focal distance within the camera module.

### FIELD OF INVENTION

The field of the invention directed to image readers and in particular to an image reader providing variable focal distance.

### BACKGROUND OF THE INVENTION

Digital imaging technology continues to improve and find widespread acceptance in both consumer and industrial applications. Digital imaging readers are now commonplace in video movie cameras, security cameras, video teleconference cameras, machine vision cameras and, more recently, hand-held bar code readers. As each application matures, the need for intelligent image processing techniques grows. To date, the large data volume attendant to transmitting a digital image from one location to another could only be accomplished if the two locations were connected by a wired means. Machine vision and imaging-based automatic identification applications required significant computing power to be effective and correspondingly require too much electricity to be useful in portable applications. The trend now in both consumer and industrial markets is toward the use of portable wireless imaging that incorporates automatic identification technology.

Historically, the automatic identification industry has relied on laser technology as the means for reading bar codes. Laser scanners generate a coherent light beam that is oriented by the operator to traverse the horizontal length of the bar code. The reflected intensity of the laser beam is used to extract the width information from the bars and spaces that are encountered. Laser scanners are effective in reading linear bar codes such as the U.P.C. code found in retail point-of-sale applications, Code 39, Interleaved 2 of 5, or the like. Information stored in these linear (1D) bar codes is used to represent a short message or an index number related to a separate data file located in a central computer.

Imaging-based scanners use a solid-state image sensor such as a Charge Coupled Device (CCD) or a Complimentary Metal Oxide Semiconductor (CMOS) imager to convert an image scene into a collection of electronic signals. The image signals are processed so that any machine-readable character or bar code found in the field of view can be located in the electronic representation of the image and subsequently interpreted. The ability of image-based readers to capture an electronic image of a two-dimensional area for later processing makes them well suited for decoding all forms of machine-readable symbology at any orientation.

An image-based scanner is made up of an optical imaging chip, light-emitting diodes (LEDs), a lens, a targeting means and other optical components such as wedges or diffusers. The lens is attached to the module housing by a threaded assembly which, when tightened and locked, holds the lens at a specific fixed distance above the imaging array. An illumination board contains the LEDs and targeting means for aiming the target symbology. The lens projects through an aperture in the illumination board which is also held in place by the module housing.

Generally, there are different types of cameras to image different types of symbology. They include ultra high definition (UHD), high definition (HD), standard (ST) and ultra long range (ULR). These cameras have a different focal distance for each of these different applications. This means that the lens is at a different distances from the imager in each of these cameras in order to provide the different focal ranges.

The distance between the imaging array and the lens determines the focal range of the camera module. Generally, this distance is calibrated and then fixed within the module assembly. To have an auto-focusing system, similar to those found in regular cameras would greatly impact the size and cost, making it an impractical feature for camera modules of the type found in image readers. Therefore, it is necessary to configure a separate camera module to accommodate the focal range of different symbology feature sizes. It is possible to use a multi-focus lens, which could take images of multiple symbols of different feature size, however this method limits the field of view of each symbol imaged thereby degrading the quality of the image.

U.S. Pat. No. 5,814,803, which issued to Olmstead et al on Sep. 29, 1998 and U.S. Pat. No. 6,073,851, which issued to Olmstead et al on Jun. 13, 2000 describe a multi-focus technique whereby a single camera module can image multiple symbologies at different focal ranges simultaneously. Since the lens is simultaneously taking the image of multiple symbologies, the field of view for each symbol is limited.

U.S. Pat. No. 5,756,981, which issued to Roustaei et al on May 26, 1998, describes a technique used in a camera module having a lens assembly that contains multiple lenses. The lenses are moved apart in relation to each other by a solenoid or motor. This allows the camera to image the symbology at different focal ranges. This technique however, is limited to a more expensive camera module with a multi-lens optical assembly, and would not be useful in single lens camera modules.

Further, U.S. Pat. No. 6,340,114, which issued to Correa et al on Jan. 22, 2002, describes a technique in which the lens assembly comprises 2 lenses each having a different focal range. A moving optical element such as a mirror is provided to select an image through either the first or second lens. This technique however, is quite complex and requires numerous extra features including dedicated mirrors, an extra lens and mechanical means such as an electronic servo mechanism to control the mirrors. These extra features would make this technique expensive and impractical for a variety of imaging applications such as image readers and barcode readers.

Presently, cameras either provide a single focal range, or provide multiple focal ranges at the expense of limited field of view (FOV) and lowered definition quality, these lenses usually must share the FOV with more than one symbol and sometimes with more than one lens.

Therefore there is a need for a camera that could accommodate more than just a single focal range while maintaining the same FOV and definition quality.

### SUMMARY OF THE INVENTION

The present invention is directed to a variable focal distance image reader comprising a lens for focusing a target on an image sensor, and an electro-mechanical system for moving the lens between at least two predetermined lens positions wherein each of the predetermined lens positions corresponds to a unique focal distance.

In accordance with a specific aspect of the invention, the lens is a single, cylindrical lens.

In accordance with another aspect of the invention, the electro-mechanical system comprises a solenoid having a coil and a plunger coupled to the lens, a current source for driving the solenoid and a control interface for controlling the current source. The plunger may be coupled to the lens by a lever.

In accordance with yet another aspect of the invention, the predetermined lens positions correspond to the focal distances required for two or more of the applications, which may include ultra high definition (UHD), high definition (HD), standard (ST) and ultra long range (ULR).

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIGS. 1a and 1b illustrate two examples of focal distances required for particular applications and;

FIG. 2 is side view of a schematic of the present invention shown within a barcode scanner.

### DETAILED DESCRIPTION

For purposes of explanation, a specific embodiment is set forth to provide a thorough understanding of the present invention. However, it will be understood by one skilled in the art, from reading this disclosure, that the invention may be practiced without these specific details. Moreover, well-known elements, devices, process steps and the like are not set forth in detail in order to avoid obscuring the scope of the invention described.

The present invention will be described with reference to the drawings where identical numerals represent similar elements throughout.

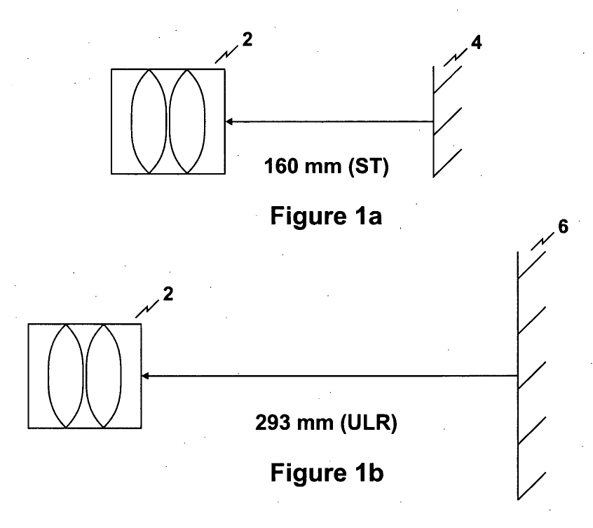

Different imaging applications require different focal distances. The focal distance is dependent on the type of lens used in the camera module. In general, the focal distance is calibrated and then fixed within the module assembly. FIGS. 1a and 1b show two examples of focal distances required for particular applications. FIG. 1a shows the focal distance required for ST applications. In this instance, the distance between the lens 2 and the ST target 4, a barcode on a grocery item for example, is 160 mm. FIG. 1b shows the focal distance required for ULR applications. In this instance, the distance between the lens 2 and the ULR target 6, a barcode on an over-sized parcel or crate for example, is 293 mm.

The present invention comprises an electro-mechanical device for moving the lens between at least two different predetermined lens positions which would allow the camera to image symbols with different feature sizes. A camera module having a single lens can be used to image symbols requiring an ultra high definition setting, wherein the symbology feature size is very small, and then, the same camera module can also be used to image standard type symbology such as 2D barcodes by changing the position of the lens. This invention eliminates the need of requiring up to four different camera modules for various features sizes of symbology.

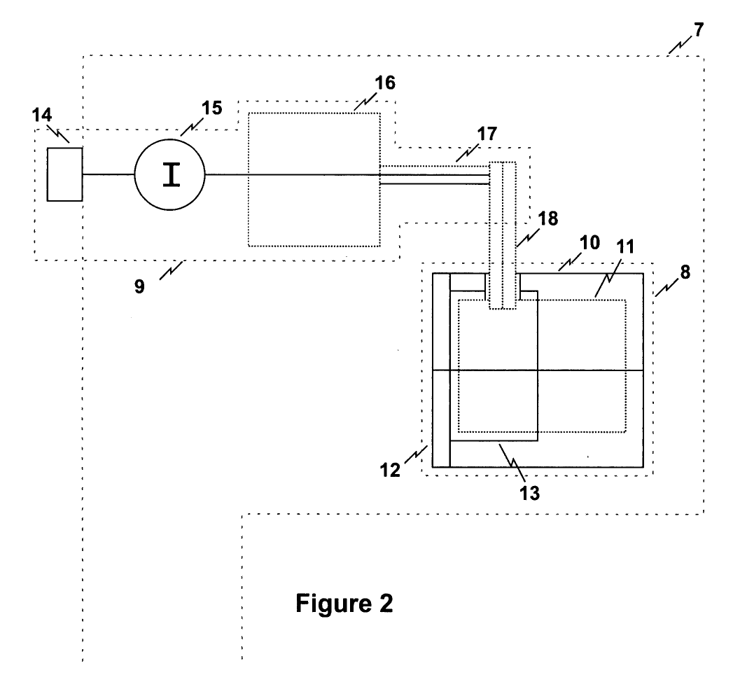

An embodiment of the present invention is shown in FIG. 2. An image reader, such as a barcode scanner 7 comprises an imager module 8 and an electro-mechanical system 9.

The imager module 8 comprises a module housing 10, a cylindrical objective lens 11 and an image board 12. The module housing 10 is basically a hollowed out shape that is used to enclose the components of the imager in a stable and rigid fashion. It is preferably constructed from some form of molded plastic. Its primary purpose is to provide rigidity to the structure, as well as to shade the image sensor from external light sources. Module housing 10 further includes a base 13, which acts to support the lens 11 as well as to shroud light from the image sensor, which is attached to the inner surface of the image board 12. The image board 12 contains some circuitry associated with the image sensor (not shown). Both housing 10 and lens 11 include holes bored into their top surface to engage with the electro-mechanical system 9.

The cylindrical objective lens 11, is a common component in the industry, a person skilled in the art would select an objective lens of the appropriate type depending on the camera application.

The image board 12 is generally a printed circuit board that provides connectivity for the electronic components as well as a physical surface with which to provide mechanical stability. A person skilled in the art could envision the use of another surface to provide the mechanical stability and to provide the components with electrical conductivity.

The electro-mechanical system 9 comprises a control interface 14, a current source 15 and a solenoid 16 having a plunger 17 connected to a lever 18. Current source 15 supplies solenoid 16 with current. Depending on the type of solenoid used, either a pull or push type, the moving plunger 17 within the solenoid 16 either pulls or pushes lever 18. Lever 18 mates with holes bored into the top surfaces of housing 12 and objective lens 11. Since lever 18 mates with a hole within objective lens 11, the pulling/pushing action of lever 18, pulls or pushes lens 11. The degree to which objective lens 11 is pulled or pushed is dependent on the magnetic force of solenoid 16, which is in turn dependent on current source 15. The amount of current that current source 15 supplies is dependent on the application and what focal distance is required. Control interface 14 is an electro-mechanical switch by which a human operator can select the desired focal distance proportional to the type of symbology, UHD, HD, ST or ULR. When a particular focal distance is selected, current source 15 will provide a proportional current to solenoid 17.

Both control interface 14 and current source 15 are measured and calibrated during the manufacturing process. Control interface 14 can take the form of push buttons, a dial or any other suitable control mechanism, where each button or each dial position selects the current required by the solenoid 16 to move the lens 11 to a particular focal length. Such control mechanisms will be apparent to those skilled in the art.

The solenoid 16 could take the form of other types of electro-mechanical transfer devices. A person skilled in the art could envision the use of a variety of motors and mechanical energy transfer components that could be used in place of the solenoid described, wherein the system converts electrical energy to mechanical motion to pull or push the lens 11 into the appropriate positions.

The present invention provides a single camera module with the ability to read symbologies with at least two different feature sizes without impacting on the definition quality of the image. Further, the present invention is a less expensive alternative to the prior art methods and it generally provides better FOV and better image quality than cameras with multi-focal point lenses.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A variable focal distance image reader comprising:
a lens for focusing a target on an image sensor; and
an electro-mechanical system for moving the lens between at least two predetermined lens positions wherein each of the predetermined lens positions corresponds to a unique focal distance.

2. The image reader of claim 1 wherein said lens is a single lens.

3. The image reader of claim 2 wherein the lens is a cylindrical lens.

4. The image reader of claim 1 wherein the electro-mechanical system comprises:
a solenoid having a coil and a plunger coupled to the lens;
a current source for driving the solenoid; and
a control interface for controlling the current source.

5. The image reader of claim 4 wherein the plunger is coupled to the lens by a lever.

6. The image reader of claim 1 wherein the predetermined lens positions correspond to the focal distances required for two or more of the following applications: ultra high definition (UHD), high definition (HD), standard (ST) and ultra long range (ULR).
